(19) United States
(12) Patent Application Publication
(10) Pub. No.: US 2019/0166814 A1
(43) Pub. Date: Jun. 6, 2019

(54) FISHING LURE AND A LINKING SYSTEM AND A METHOD OF MANUFACTURING THEREOF

(71) Applicant: Larry Hobbs, Mesa, AZ (US)

(72) Inventor: Larry Hobbs, Mesa, AZ (US)

(21) Appl. No.: 16/208,452

(22) Filed: Dec. 3, 2018

Related U.S. Application Data
(60) Provisional application No. 62/594,533, filed on Dec. 4, 2017.

(51) Int. Cl. A01K 85/18

(52) U.S. Cl. CPC A01K 85/18

(57) ABSTRACT

A fishing lure and linking system in the general shape of a lizard includes a body portion, a head, and a tail. One or more appendages can be attached to the body portion, wherein a linking system can be molded into the head, and body portion. A linking system can include a forward pivot, and aft pivot with a middle rod connecting the two creating the connection rod. One or more connection rods can create the complete linking system wherein the forward pivot and the aft pivot can connect additional connection rods forming a chain wherein at each pivot section the fishing lure can move, and fluctuate as the species it is trying to emulate. A wobble device can be incorporated either before the molded fishing lure, or within the fishing lure's mold. Alternatively, the linking system can be incorporated into other species types such as a fish, frog, or worm.

### CROSS REFERENCE TO RELATED APPLICATIONS

The present application claims the benefit under 35 U.S.C. 119 of U.S. Provisional Patent Application Ser. No. 62/594,533 filed Dec. 4, 2017. The U.S. Provisional Patent Application Ser. No. 62/594,533 is hereby incorporated by reference in its entirety.

### TECHNICAL FIELD

The present invention relates to a fishing lure and, more particularly, to a lifelike fishing lure in shape of a lizard or other species having appendages and a body that flutter when acted on by water. The lure contains an internal linking system that which increases the fishing lures flexibility and further generates wobble, thereby giving the lure more lifelike characteristics as it fluctuates through the water.

### BACKGROUND

Various types of fishing lure devices are known in the art. Fisherman are continually looking for ways to improve catching fish more consistently, and many different devices have been developed to help in this endeavor. Typically, a fisherman chooses a lure that looks, and moves in the water like the prey animal of the fish that the fisherman is trying to catch. Fish frequently prey on animals such as a lizard, a tadpole, a frog, a crayfish, and a worm. Live lizards usually swim through the water by moving their legs and tail in a fluctuating manner. Under duress a lizard will commonly reacts with a rapid action of their appendages to propel themselves forward more quickly through the water. The rapid action of the lizard and its respective appendages can create a pressure wave in the water that predatory fish can recognize and as a result will try to eat the lizard.

Lures have been developed to mimic, in a rudimentary way, the appearance and the behavior of the species it is trying to emulate. These lures can rely on either a passive movement as it moves through the water, or may have a complex system of mechanical parts that improve lifelike movement but are prone to malfunction and may be difficult to manufacture and assemble. In addition, fishermen optionally use bare and weighted hooks, jig heads, spinner bait harness and other hook arrangements known to those who are skilled in the art.

Plastic lures can be molded into a worm, a frog, or a lizard configuration having segments that are attached to a jig head. These lures are usually fished on the bottom of a body of water as the lead or metal portion of the jig head, which can cause the lure to sink to the bottom and simulate either a swimming, or crawling action of the species it is trying to emulate. The lure will further include a hook passing through the lure's mouth and out through either the bottom or top surface of the species it is trying to emulate. The hook frequently must be stiff to allow the user to force the hook through the plastic, rubber, or silicon body of the lure, thus making the species' body stiff and unable to simulate the species' movement.

A further disadvantage of current lures is that they are often time consuming, tedious and difficult to rig. As a result, such lures lack consistency in how they are joined to a fishing line, and how the hook it placed through the body of the lure. As a result, such lures lack consistency. For example, a lure that is improperly rigged might be able to swim straight, or may sink too quickly or float to the surface making the lure ineffective. Additionally, the nature of the rigging process can limit the reusability of the lure components being used. As a hook is constantly inserted into the species' body a hole is created, and the hook can eventually tear through the lure's body, making the lure unusable. It would be advantageous to provide a fisherman a lure that enables him/her to use a lure like a lizard, frog, or worm or the like that looks, feels, and moves like the species it is trying to emulate, and that naturally emulates the species movement without the long rigid hook going through its body, allowing the fishermen to catch more fish and reuse the lure.

### SUMMARY

In some embodiments of the system and method of the invention, a fishing lure is provided having a lure body that has a head and a tail and, optionally, appendages to mimic the natural prey of a fish or something a fish would like to eat. The fishing lure has a linking system incorporated and secured within the body of the lure including at least one pivot that allows the linking system to flex and move at the position of the pivot. The body of the lure may be formed of a polymer, plastic, or rubber and the linking system and pivots of the linking system can mimic the structure and movement of bones and joints of an animal species. The linking system can have a forward pivot near the head of the lure and an aft pivot near the tail of the lure. Specifically, the body, the head, and tail are flexible and the structure of the linking system within the body is configured to emulate the movement of an animal species as it swims through water. The tail and appendages of the lure can be shaped such that the aerodynamics of the lure moving the water creates a specific movement of the lure through the water. The lure can include a wobble device to magnify the fluctuation of the body and tail of the lure, a swivel, a line and a weight.

In one embodiment, the linking system can further comprise a vertical connection which has a bottom loop and a top loop such that a hook can be attached to the bottom loop. Other links can connect connection rods together as part of the linking system. In one embodiment, the links are accessible to a user to optionally attach appendages or other accessories to the lure at the position of the links. The body portion, the head, and the tail can also have a plurality of reflective pieces integrally formed within to catch the attention of the fish. In particular embodiments, the fishing lure is shaped to resemble a lizard, frog, fish, or worm.

The invention further comprised a mold to manufacture a fishing lure, the mold having a having a bottom section and a top section that can be combined to make a cavity defining the body of the fishing lure and an injection point through which material may be inserted into the cavity that allows a linking system to be held in place while the cavity is filled with material to form a unitary artificial fishing lure. The top and bottom section can also be shaped to create one or more appendages as part of the body of the lure.

A washer cavity may be included as part of the mold to accommodate a washer and a vertical connection rod. The washer cavity supports the washer and the vertical connection rod, and the vertical connection rod in turn can support the linking system to hold it in position when the mold is filled. The mold cavity can support a plurality of connection rods extending towards a forward portion of the cavity and exiting out of the fishing lure's head wherein the connection rod is centered and placed towards the forward portion of the cavity. The linking system can be accommodated in a receptacle such that gravity holds the linking system in place when the cavity of the mold is filled or the cavity can have a connection point for a taut line or other support structure that can hold the linking system in place when material is inserted into the mold through the injection point. In a particular embodiment, the cavity is in the form of a lizard, frog, fish, or worm.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for” performing the function of molding a fishing lure, without also reciting in such phrases any structure, material or act in support of the function. Thus, even when the claims recite a “means for performing the function of molding a fishing lure, step for performing the function of molding a fishing lure,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 shows a side view of a fishing lure with a linking system in accordance to one, or more embodiments;

FIG. 2 shows a top view of a fishing lure with a linking system in accordance to one, or more embodiments;

FIG. 3 shows a bottom view of a fishing lure with a linking system in accordance to one, or more embodiments;

FIG. 4 shows a cross-sectional view of a fishing lure with a linking system in accordance to one, or more embodiments;

FIG. 5 shows a cross-sectional view of an additional embodiment of a fishing lure with a ball joint linking system in accordance to one, or more embodiments;

FIG. 6 shows a cross-sectional view of another embodiment of a fishing lure with a pivot pin linking system in accordance to one, or more embodiments;

FIG. 7 shows a cross-sectional view of an additional embodiment of a fishing lure with a wire linking system in accordance to one, or more embodiments;

FIG. 8 shows a cross-sectional view of another additional embodiment with appendages attached to a fishing lure with a linking system in accordance to one, or more embodiments;

FIG. 9 shows a cross-sectional view of another additional embodiment with appendages attached to a fishing lure with a linking system in accordance to one, or more embodiments;

FIG. 10 shows a cross-sectional view of another additional embodiment with appendages attached of a fishing lure with a linking system in accordance to one, or more embodiments;

FIG. 11 shows a cross-sectional view of another additional embodiment with appendages attached of a fishing lure with a linking system in accordance to one, or more embodiments;

FIG. 12 shows a cross-sectional view of alternative form of a fishing lure with a linking system shaped as a fish in accordance to one, or more embodiments;

FIG. 13 shows a cross-sectional view of additional alternative form of a fishing lure with a linking system shaped as a frog in accordance to one, or more embodiments;

FIG. 14 shows a cross-sectional view of an apparatus for molding a fishing lure with a linking system in accordance to one, or more embodiments; and

FIG. 15 shows a cross-sectional view of another apparatus for molding a fishing lure with linking system.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

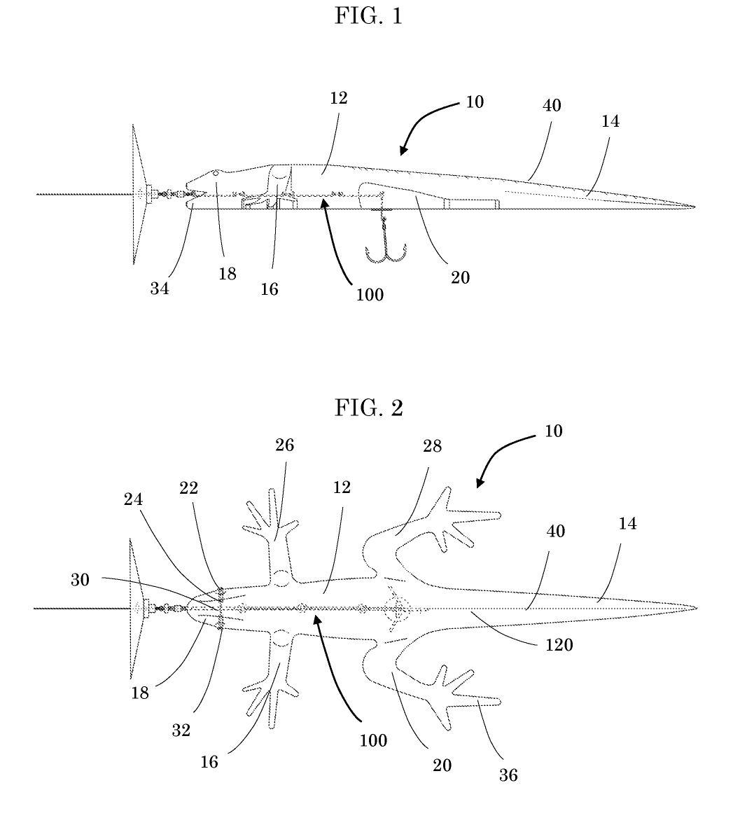

Referring initially to FIG. 1 and FIG. 2, a fishing lure 10 is shown. In a preferred embodiment, the fishing lure 10 can comprise a body portion 12 having a tail 14, a head 18, and one or more appendages 16, 20, 26, 28 which can simulate for example, a lizard. A fishing lure 10 can further comprise a linking system 100, wherein the linking system can sit substantially centered along the axis of the fishing lure's body portion 12. The fishing lure 10 can be formed by casting a mold in the shape of the lure, inserting molten plastic into the mold, and allowing the plastic to set in the shape of the mold. Prior to the mold process, the linking system 100 can be set within and substantially centered in the cast of the mold. The mold can be in the form of a lizard, frog, fish, or other animal that is the natural prey of a fish, or any other shape desired by the fisherman. The fishing lure 10 can be made of soft, resilient, flexible plastic, and in certain embodiments the fishing lure can be made of for example, foam, wood, plastic, rubber, metal, cork, or the like. In addition, as the fishing lure's 10 plastic is in its melted state it could be optionally impregnated with one or more types of attractants (not shown) for example, glitter, sparkles, beads, or the like that can simulate the skin color of the species the fishing lure is trying to emulate and additionally help attract fish.

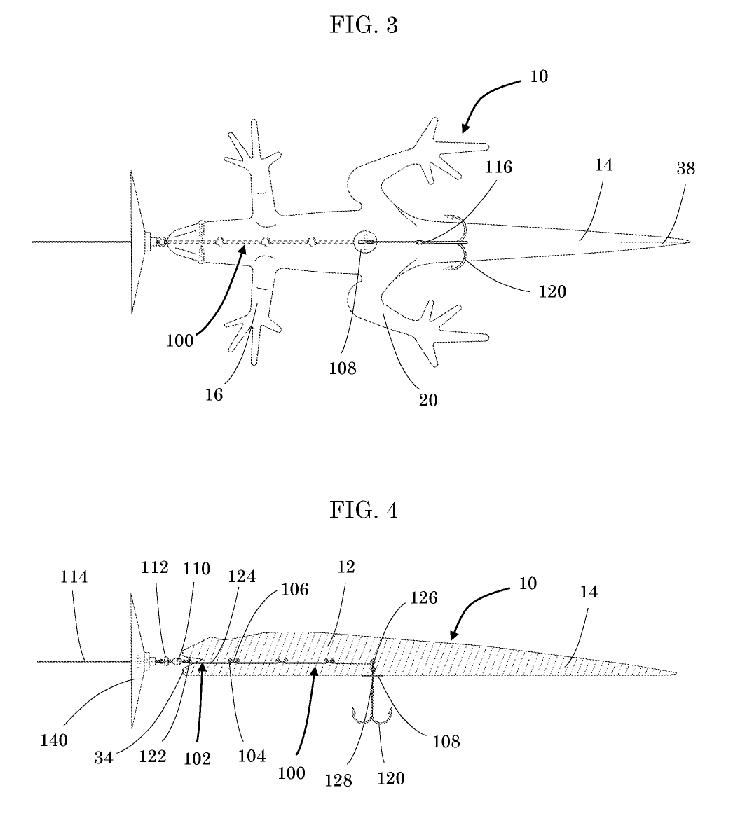

Referring to FIG. 2 and FIG. 3, in some embodiments, the head 18 can be connected to the body portion 12, and can be generally triangularly blocked shaped, arrow shaped, flat in shape, or the like with a crest on top to allow the lure to easily swim through the water without frontal resistance. The head 18 can have one or more eyes 22, 32 attached to the head's side, and to the head's opposing side by an eye attachment 24 which can be for example wires, plastics, pins, or the like and where the wire can have two wound sections, and a straight section 30 between each wound section. The eye attachment 24 can be inserted into the head 18, and each eye 22, 32 can be attached to the wound ends by for example, glue, pins, stamped into, or the like. Alternatively, the eyes 22, 32 can be connected to the head 18 by glue, string, plastic, or the like.

In some embodiments, the head 18 can have a mouth 34 (as shown in FIG. 1) that is open which can allow the linking system 100 to enter the fishing lure's body portion 12. In some embodiments, a mouth 34 can be closed, and can be in the shaped like a lizard, fish, frog, or the like. A mouth 34 can have a weight, teeth, a wobble device, a swivel, a bead, a ball sinker, or the like integrated within the mold, or removably connected to the mouth by a link or linking system 100. In some embodiments, the mouth 34 can be omitted. In certain embodiments, a mouth 34 can have a wobble device 140 integrated within the head where a mold can have a section for the wobble device to sit within the front of the lure's head whereas the plastic is poured in the mold the wobble device can be integrated within the lure's head with either a hole that can pass through the wobble system for the linking system to attach directly to a line 114, or a swivel where it can be integrated with the wobble device and molded within the head, and then attached to a line.

In embodiments, the body portion 12 can extend from the head 18 to the tail 14 having a generally elongated cylindrical or oval shape with a forward, and aft end wherein the forward and aft end can connect to one or more appendages 16, 20, 26, 28 extending either perpendicularly from the body, or in parallel with the body, and the aft end can be connected to the tail 14. The body 12 can gradually increase in size, or can be one size generally extending from the forward to the aft end, or from the front appendages 16, 26, to the back appendages 20, 28. The body portion 12 can be formed of suitable material such as, but not limited to, polymers, soft plastics, metal, fiberglass, or epoxy resins. In certain embodiments, the body portion 12 and/or head 18 can have a weight(s) incorporated within itself, or the body portion can have an air pocket extending generally from the forward to the aft end thus allowing the fishermen to choose whether the lure will float or sink.

The appendages 16, 20, 26, 28 can be arms, legs, fins, or the like. In a preferred embodiment, the appendages 16, 20, 26, 28 can extend outwardly away from the body in the shape of arms and/or legs, and can have one or more digits 36, which can be for example, fingers, toes, spines, or the like attached to the appendages. In the preferred embodiment, the appendages 16, 20, 26, 28 can be molded with the body 12 as one piece. In certain embodiments, the appendages can be molded as one or more pieces separate from the body 12, and can be removably or permanently attached to the body by for example, flexible rubber, hinged metal links, hinged plastic, or the like. The appendages 16, 20, 26, 28 can be made from the same material as the body 12, and in some embodiments the appendages can be made of for example, plastics, foams, woods, metals, or the like.

The tail 14 can be attached to the body 12 as one piece and can extend rearwardly from the body and defines the rear end of the fishing lure 10. The tail 14 can be shaped, for example, concave-shaped or convex-shaped to define the motion of the lure as it is moves through the water action. For example, the tail's 14 shape can flutter through the water acting as the lure is using its tail to propel itself through the water. In a preferred embodiment, the tail 14 can taper in thickness away from the body 12 and toward the tail's aft end 38 ending in a radius or blunt end. To optimize the effectiveness of the tail 14, the tail extends to a length that can be for example, between 2 inches and 6 inches, more preferably a length of between 3 inches and 5 inches, and still more preferably a length of approximately 3.5 inches. The tail 14 can have a greater thickness at the apex of where it meets the body 12, and the aft appendages 20, 28. The tail 14 can have a small peak 40 long the top of the tail which can work in combination with the tail's shape to produce an undulating motion as the tail captures, and moves through the water. In some embodiments, a tail 14 can create a side to side motion, or a top to bottom motion giving the lure different types of effects as it moves through the water. In addition, as the tail 14 can produce a quivering, amoeba-like, or breathing effect by its tail and body 12 as it moves through the water, or as the user jerks the lure through the water to give the fish the sense that the lure is alive.

Referring to FIG. 4 a cross-sectional view of a fishing lure 10 with a linking system 100. The linking system 100 can comprise of one or more connection rods 102 that can move relative to each other by connecting pivots 122, 104. The connection rod 102 can be made of one piece having a forward pivot 122, an aft pivot 104, and a middle connection 124. The forward pivot 122 and aft pivot 104 can be circular, square, rectangular, or the like in shape, or may be a section of flexible material or any other joint that can allow one connection rod 102 to bend or move relative to another. In a particular embodiment, the rods 102 are simply separated from each other and held in place by the material of the body 12 surrounding the connecting rods 102. The middle connection 124 can be a straight or shaped rod, and can attach the forward pivot 122 to the aft pivot 104 together forming the entire connection rod 102. In alternative embodiments, the connection rod can be made of one or more sections having the forward pivot 122, aft pivot 104, and middle connection 124 being separate sections, and each section permanently attached to each other by for example, weld, glue, wire tie, spot weld, or the like. The connection rods 102 can be made of for example, wire, plastic, rubber, stainless steel rods, springs, or the like. The connection rods 102 can be for example, between 0.25 inches and 1 inch, more preferably a length of between 0.375 inches and 0.75 inches, and still more preferably of approximately 0.675 inches in length. The connection rod 102 thickness can be for example, between 0.05 inches and 0.25 inch, more preferably between 0.075 inches and 0.125 inches, and still more preferably of approximately 0.1 inches.

In embodiments, one or more pivots 122, 104 may comprise a link 106, or one or more links 106 can be removably or permanently attached to either or both the forward pivot 122 and the aft pivot 104, wherein two or more connection rods 102 can be connected to each other by the link to the forward pivot 122 or the aft pivot 104. The link 106 can be circular, square, rectangular, hexagonal or the like in shape. The link 106 can be made generally of wire, however in other embodiments it can be made of rubber, plastic, stainless steel rods, or the like. The links 106 can be for example, between 0.075 inches and 0.5 inch, more preferably a length of between 0.125 inches and 0.375 inches, and still more preferably of approximately 0.15 inches in length. In another embodiment, the link 106 can be omitted and the connection rod 102 can be connected to each other by its forward, and aft pivots 122, 104.

The links 106 may be accessible through the body 12 of the lure 10, by for example, a cavity or cutout (not shown) in the body that allows the user to access the links 106 and attach various accessories to the links 106, such as a hook 120 optional appendage (not shown) or a body shape (not shown) to affect how the lure moves through the water. The links 106 allow the user to optionally determine the ideal body shape of the lure and can determine an ideal placement for the hook 120 or an ideal movement of the lure in the water to attract fish in connection with the techniques employed by the user. In a particular embodiment, the links 106 may allow a modular system, in which the user can attach a variety of differently shaped optional appendages to a central hub or in a sequence that creates any body structure desired by the user.

In still another embodiment, the body 12 of the lure may have at least one weight cavity (not shown) in which weights can be securely placed to allow the user to adjust the weight of the lure. The weight cavities (not shown) can be strategically placed to allow the user to better approximate the look and feel of an animal by optionally placing weight in various positions on the body 12 of the lure.

The aft pivot 104 and the link 106 can be attached to another connection rod's 102 forward pivot 122 and link, which can form one or more pivot points at each link and forward pivot/aft pivot connection point within the linking system 100. The pivot point can be located for example, where the head and body are joined, where the front appendages are joined to the body, at about the mid-point of the body, and where the aft appendages meet the body creating additional pivots points through the fishing lure approximating the pivoting action of the spine or other bone structure joints of the species the lure is intended to approximate. In certain embodiments, the pivot points can be located every for example, between 0.25 inches and 1 inch, more preferably between 0.375 inches and 0.75 inches, and still more preferably of approximately 0.675 inches. The forward pivot 122, the aft pivot 104, and link 106 pivot point can rotate around each other at, where the connection rod 102 and the following connection rod can be parallel with each other at 0 degrees, and can rotate horizontal and vertically for example, between 180 degree to −180 degrees, more preferably between 90 degrees and −90 degrees, and still more preferably of approximately +/−45 degrees.

In embodiments, a linking system 100 can be placed into and molded into the fishing lure 10, generally through the mouth 34, and the body 12. The connection rods 102 can be linked and extend to about the middle of the back appendages 20, 28. In other embodiments, the connection rods 102 can extend to about the front of the back appendages, to about the middle of the back appendages, to about the back of the back appendages. In a particular embodiment, the linking system can be pierced through the solid body 12 of the lure and secured by an anchor (not shown) that prevents the linking system 100 from being pulled back through the body 12 of the lure. In the preferred embodiment, the connection rods 102 can extend generally from about the middle of the body 12 to the back appendages 20, 28, where a vertical connection rod 128 can extend vertically from the aft pivot 104 and can be connected by a vertical link 126. A vertical connection rod 128 can extend vertically from the aft pivot 104 at for example, between 0 degree to 120 degrees, more preferably between 40 degrees and 110 degrees, and still more preferably of approximately 90 degrees. The vertical connection rod 128 can be for example, between 0.125 inches and 0.75 inch, more preferably between 0.25 inches and 0.675 inches, and still more preferably of approximately 0.375 inches. The vertical connection rod 126 can have a forward and aft pivot point where the pivot points can be circular, square, rectangular or the like in shape. The vertical connection rod 126 can be preferably a wire, but in other embodiments it can be plastic, rubber, metal, or the like. The vertical connection rod 126 thickness can be for example, between 0.05 inches and 0.25 inch, more preferably between 0.075 inches and 0.125 inches, and still more preferably of approximately 0.1 inches.

The vertical link 126 can removably or permanently connect the connection rod's 102 aft pivot 104 to the top of the vertical connection rod 128. A vertical link 126 can be circular, square, rectangular, hexagonal or the like in shape. The vertical link 106 can be made generally of a wire, however in other embodiments it can be made of rubber, plastic, stainless steel rods, or the like. A vertical connection rod 128 and vertical link 126 can create a vertical pivot point where the pivot point can allow the lure's body to bend both horizontally and vertically at for example, between 180 degree to −180 degrees, more preferably between 90 degrees and −90 degrees, and still more preferably of approximately +/−45 degrees. Each pivot point in the fishing lure's 10 head 34, body 12, and tail 14 give the fishing lure the ability to bend and freely swim through the water without the stiffness of a wire or hook going through the head, body and tail. As the fishing lure 10 swims through the water the shape of the body, head, tail, and the pivot points give the lure the ability to swim like the species it is trying to emulate, for example a lizard has an undulating motion as the body and tail captures, and moves through the water.

A linking system 100 can further comprise a washer 108, and a hook 120. A washer 108 can encapsulate the vertical connection rod 128 and can be attached to the bottom of fishing lure's 10 body by for example, glue, push pins, press fit, spikes, or the like. The washer 108 can be circular, square, triangular, oval, concave, convex, or the like, and can have a hole in the middle that can tighten down on the vertical connection rod 128 as it is pushed towards the fishing lure's body 12. In other embodiments, a washer 108 can have one or more slits that form an “x” or a “t” that tighten down on a vertical connection rod 128. In embodiments, the washer 108 can be for example, internal tooth lock washer, push nut washer, retention washer, spring steel washer, or the like, and it can vary in diameter or shape. The washer 108 can be made from steel, thermoplastics, nylon, ceramics, rubber, brass or the like. The washer 108 can be clear, black, white, or can match the color of the fishing lure. In certain embodiments, a washer can be replaced with a cap push nut with a hole through its center, a mounting flange, an unthreaded spacer, a shim, or the like. The washer 108 can hold the vertical connection rod 128 to the fishing lure's body 12, or tail 14 spreading the tension from the pull of the fish over a larger surface area on the bottom of the body or tail.

In embodiments, the vertical connection rod 128 can be removably connected to the hook 120 at its lower end by a loop, and/or pivot joint on the end of the vertical connection rod. The loop and/or pivot joint can be a metal loop, nylon loop, plastic loop, or the like. In certain embodiments, a swivel, a fishing line, a snap ring, a knot, or the like can attach between the hook 120 and the vertical connection rod 128. The hook 120 can be for example, a treble hook, a double hook, weedless hook, bend down hook, or the like. The hook 120 is preferably formed of stainless steel, however, in other embodiments it can be made of brass, aluminum, nylon, plastics, or the like. The hook 120 can have an eye formed on one end, and on the other side of the curved ends a barb.

In embodiments, the linking system 100 can further comprise a swivel 110, a weight 112, a wobble device 140, and a line 114. The swivel 110 can comprise of two rings connected to a pivoting joint, and can be made of stainless steel, brass, nylon, plastics or the like. The swivel 110 can be removably or permanently connected to the connection rod's 102 forward pivot 122 on its aft end, and on its forward end, or in certain embodiments it can be attached to a weight, or a line, or a wobble device. The swivel 110 can be for example, ball-bearing swivel, barrel swivel, torpedo swivel, box swivel or the like. In some embodiments, the swivel 110 can be omitted. The swivel 110 allows the fishing lure 10 and line 114 to untwist, or not twist during the fishing lure's retrieval, preventing the line from being tangled. In addition, the swivel can stop the weight, or bobble device from sliding against the fishing lure's 12 mouth 34.

The weight 112 can be attached or can be between the swivel and the wobble device 140 on the line 114, or can be behind the swivel, or directly on the wobble device. The weight 112 can be for example a fishing sinker, knock, pyramid sinkers, barrel sinkers, bank sinkers, or the like. Adding weight 112 to the fishing lure 10 can traditionally maintain the fishing lure near the bottom of the body of water, and thereby presents the fishing lure to the fish at the proper depth. To maintain a more precise depth control and to provide a means for allowing the fishing lure 10 to stay at the desired depth weights can be added or taken away from the fishing lure depending on the desired depth. In addition, the weight 112 can be added to accommodate different fishing styles for example, retrieving the fishing lure from a boat, or from the shoreline. In certain embodiments, the weight 112 can be omitted from the fishing lure 10, and the swivel 110 can be connected to the fishing line 114, and/or wobble device 140, and/or attached to the swivel.

In embodiments, a wobble device 140 can be connected to, inserted on, or attached to a line 114. The wobble device 140 can comprise of a cup, or a cone shaped guide having an apex and a rim wherein the rim can have a line guide thru the hole substantially centered on the cup and the rim. The cup shape can be oriented so that it is generally facing the fishing poll, and the line 114 can be inserted through the line guide thru hole. The wobble device 140 can have a circular front, and gradual decrease in size down to the rim. When the fishing lure 10 is reeled through the water the wobble device 140 can slide freely on the line and press up against any combination of the following items: the weight 112, the swivel 110, or the fishing lure's mouth 34. The wobble device deflects the water around the fishing lure 10, and helps magnify the fishing lure's natural undulating motion. In other embodiments, a wobble device can be half a sphere, cone with flat top, pyramid with flat top, or the like. The wobble device 140 can be made of clear plastics, metals, composites, nylons, and can include internal and external finishes such as glitter, sparkles or the like to act as an attractant for the fish. In certain embodiments, the wobble device 140 can be omitted. In certain embodiments, the wobble device 140 can be molded into the head 18 or mouth 34 of the fishing lure, and the swivel 110, and the weight 112 can be on the forward side of the wobble device toward the fishing line. In yet another embodiment, the wobble device 140 and weight 112 can be molded into the head 18 or mouth 34 of the fishing lure.

In embodiments, the line 114 can be attached on one end to a swivel by a knot, or in other embodiments, the line can be attached to a connection rod's 102 forward pivot 122, or it can be connected to a weight 112, and on the other end a rod and reel. The line 114 can be made from for example, nylon, monofilament, polyvinylidene, polyethylene, Dacron, Dyneema, steel, titanium or the like. Using a rod and reel, an angler can move the fishing lure 10 through the water with the line 114. The line 114 can pass through the wobbler's 140 thru hole, or it can be directly attached to the fishing lure by the connection rod's 102 forward pivot 122, or to the swivel, or to the swivel.

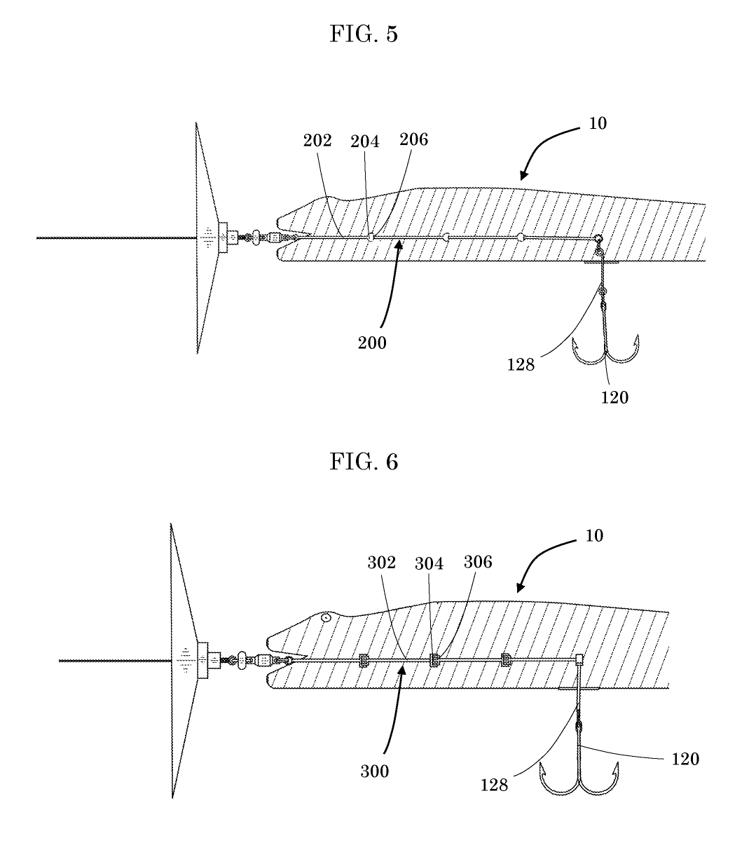

Referring to FIG. 5, a close-up, cross-sectional view of additional embodiment of a fishing lure 10. In embodiments, a linking system 200 can be a ball and joint system comprising a ball 206, a housing body 204, and a shaft 202 wherein the ball, and the shaft can be one or two pieces permanently attached to each other, and the housing body and the shaft can be one or two piece permanently attached to each other forming one linking system 200. The ball 206 can be a sphere where it can move freely within the housing body 204, where the housing body can contain the ball and allow it to rotate freely in both the +/−y direction, and +/−x direction inside of the housing body. The ball 206, and the shaft 202 section, and the housing body 204 and the shaft can be one complete piece, or a plurality of pieces connected to each other. The ball 206, and the shaft 202 section, and the housing body 204 and the shaft assembly can be connected in one or more ball, shaft, housing body sections forming a chain of sections. The ball 206, shaft 202, and housing body 204 sections can have one or more sections connected to each other, and can come to an end at about or at the back appendages (not shown), where it can be connected to a vertical rod 128 that can be connected to a hook 120.

Referring to FIG. 6, a close-up, cross-sectional view of another embodiment of a fishing lure 10 and linking system 300. In embodiments, a linking system 300 can be a combination of a vertical joint 304, a horizontal joint 306, and a shaft 302 creating a vertical pivot, and a horizontal pivot, so at each joint the fishing lure 10 can pivot both in the horizontal, and vertical direction, or at any combination of angles in both the +/−y direction, and +/−x direction. The vertical joint 304, a horizontal joint 306, and a shaft 302 sections can have one or more sections connected to each other, and can come to an end at about or at the back appendages (not shown), where it can be connected to a vertical connection rod 128 that can be connected to a hook 120.

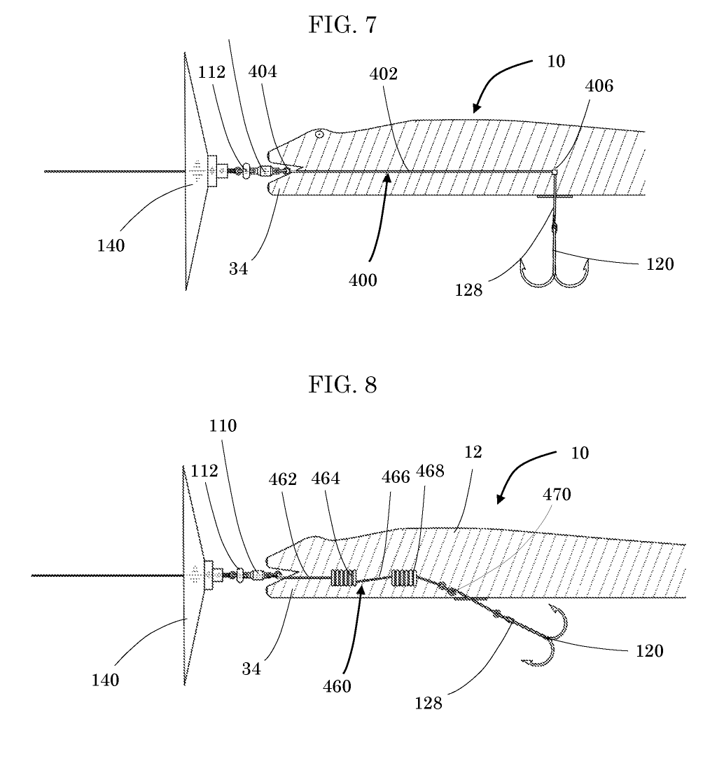

Referring to FIG. 7, a close-up, cross-sectional view of additional embodiment of a fishing lure 10 and linking system 400. In embodiments, a linking system 400 can comprise of a wire 402 having a forward loop 404, and a back loop 406. The wire 402 can extend from the mouth 34 through the body 12 to before, about, or at the back appendages (not shown) where a loop 406, or 90-degree section can connect the vertical connection rod 128 which can be connected to a hook 120. A wire 402 can be for example, stainless steel, nylon, brass, thread, steel, or the like. The forward loop 404 can be connected to any combination of the wobbler device 140, the swivel 110, or the weight 112.

Referring to FIG. 8, a close-up, cross-sectional view of additional embodiment of a fishing lure 10 and linking system 460. In embodiments, a linking system 460 can comprise of a wire 462 having a forward spring 464, and a back spring 468. The wire 462 can have one or more springs positioned through the body 12 connected by spring or connection rod 466 to allow for lure movement while being pulled through the water. The wire 462 can extend from the mouth 34 through the body 12 to before, about, or at the back appendages (not shown) with one or more springs 464, 468 positioned throughout the body, where a spring wire 470, or 90-degree section can connect the vertical connection rod 128 which can be connected to a hook 120. In some embodiments, a vertical connection rod 128 can be omitted and the spring wire can be connected directly to the hook 120. A wire 402 can be for example, stainless steel, nylon, brass, thread, steel, or the like. The forward spring 464 can be connected to any combination of the wobbler device 140, the swivel 110, or the weight 112.

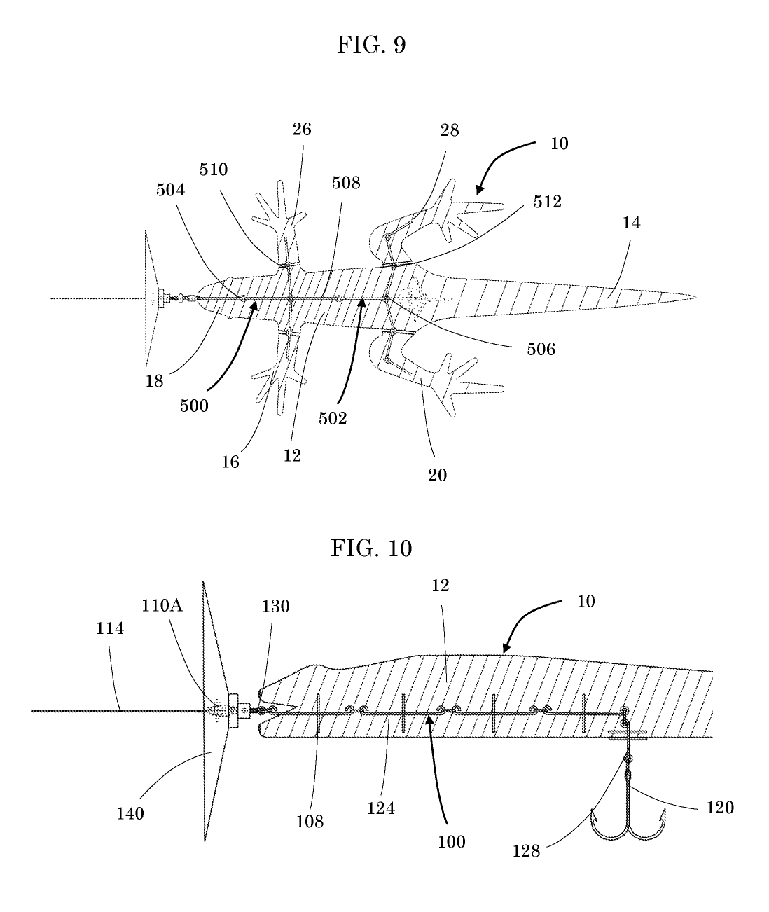

Referring to FIG. 9, a cross-sectional view of additional embodiment of a fishing lure 10 and linking system 500. In embodiments, a fishing lure 10 can comprise of one or more appendages 16, 20, 26, 28 removably attached to a body 12 by a linking system 500. A linking system 500 can comprise of one or more connection rods 502 having a forward pivot 504, and an aft pivot 506, and a middle connection 508. The appendages 16, 20, 26, 28 can be connected to the body 12 by one or more connection rods 502 with a forward and aft pivot at the section where the appendages are separated from the body, which can allow the appendages to freely rotate and move as it is being pulled through the water. The appendages 16, 20, 26, 28 can have one or more connection rods 502 within the molded appendage. In embodiments, the fishing lure 10 can be manufactured by one or more molds wherein the head 18, body 12, and tail 14 can be one mold and the appendages 16, 20, 26, 28 can be one or more molds, or the fishing lure can be one mold with multiple cavities.

Referring to FIG. 10, a cross-sectional view of additional embodiment of a fishing lure 10 and linking system 100. In embodiments, a linking system 100 can comprise of one or more connection rods 102. The connection rod 102 can be made of one piece having a forward pivot 122, an aft pivot 104, and a middle connection 124. A linking system 100 can have one or more connection rods linked together to form a continuous linking system up or until about the aft appendages (not shown) 20, 28. One or more middle connections 124 can have one or more washers 108 positioned at about the center of each of the middle connections 124. In some embodiments, a washer 108 can be on every connection rod 102, or it can be on every other connection rod, or it can be on every third connection rod, or it can be on the first and last connection rods, or every other connection rod, or the like, or in other embodiments there can be one or more washers 108 on each connection rod having a washer on its forward portion, and/or on its aft portion, and/or centered on the connection rod. A washer 108 can encapsulate the middle connection 124 through its hole centered on the washer. A washer 108 can be inserted onto and permanently attached to the middle connection 124 before the mold of the fishing lure 10 is poured. The washer 108 can resist the tension from a fish as it pulls on the hook 120, linking system 100 and line 114, and it can spread the tension across the hook, linking system, and line across a larger area of the fishing lure into its body so that the linking system does not pull out of the body 12. In certain embodiments, a swivel 110A can be in front of and sit inside of a wobble device 140. The line 114 can be tied to the forward end of the swivel 110A, and a second line 130 can be attached to the aft end of the swivel where the wobble device can be inserted into the second line. The second line's 130 aft end can be attached to the forward end of a connection rod 124.

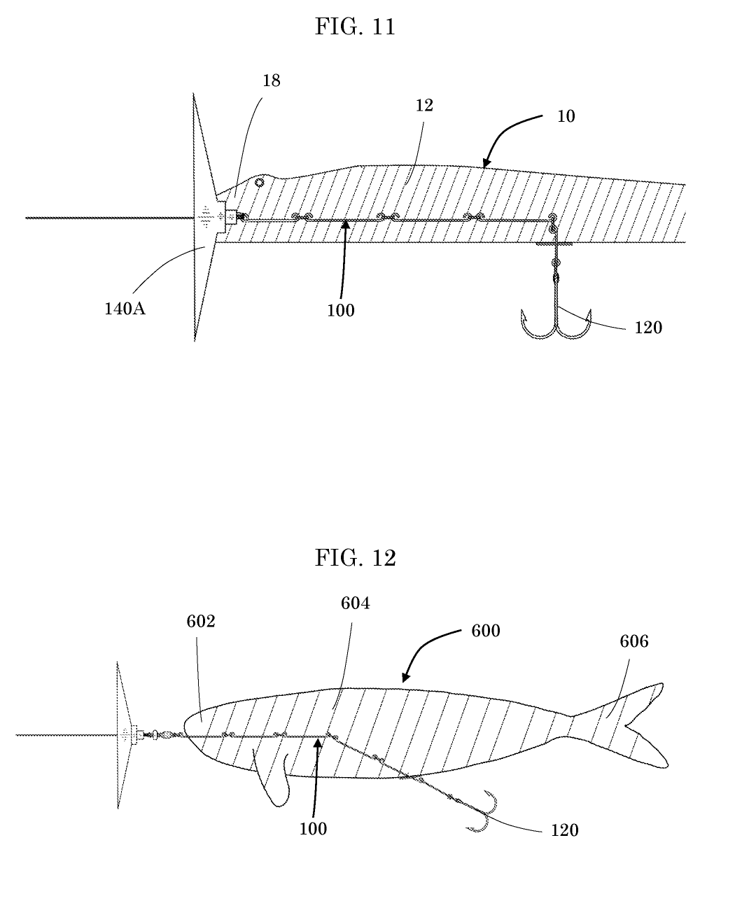

Referring to FIG. 11, a cross-sectional view of additional embodiment of a fishing lure 10 and linking system 100. In embodiments, a wobble device 140A can be molded into the front of the head 18 where the wobble device can be integrated into the head as one or more pieces. In the arrangement shown the linking system 100 can be molded into the head 18, and body 12 and the wobble device 140A can be connected to the linking system 100 within the head, or can be integrated into the head without any connection. In certain embodiments, a wobble device 140A can be melted into the mold, or molded as one piece into the mold creating a one or multiple pieces. The wobble device 140A can be rubber or plastic, creating stiff wobble device for the water to create Eddie currents or the like around the fishing lure as it moves through the water.

Referring to FIG. 12, a cross-sectional view of an alternative form of a fishing lure 600 having a head 602, a body 604, a tail 606, and the linking system 100. The linking system 100 can pass through the head 602, and body 604 through its forward portion. The linking system 100 can be connected to a hook 120. The linking system 100 can allow the fishing lure to swim through the water like the species it is trying to emulate. The linking system can have one or more connection rods with a pivot point at its forward and aft end allowing the body to freely fluctuate as it swims through the water. A form of the fishing lure 600 is such that it can be molded to have a realistic simulated shape, and proportions of a small fish. Further, the body segments can be molded to be a distinct and realistically shaped like a fish. The fishing lure 600 in the fish arrangement may be molded, for example, from plastic material to a shape simulate multiple fish species.

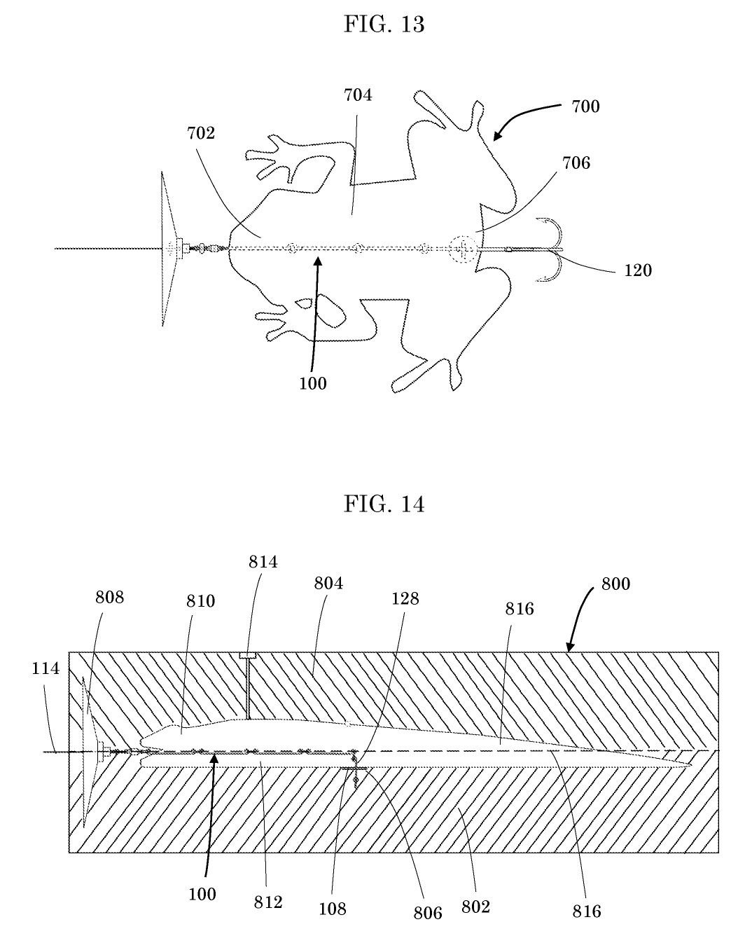

Referring to FIG. 13, a cross-sectional view of an alternative form of a fishing lure 700 having a head 702, a body 704, a tail 706, and linking system 100. The linking system 100 can pass through the head 702, body 704, and aft section 706 through its forward portion. The linking system 100 can be connected to a hook 120. The linking system 100 can allow the fishing lure to swim through the water like the species it is trying to emulate. The linking system can have one or more connection rods with a pivot point at its forward and aft end allowing the body to freely fluctuate as it swims through the water. A form of the fishing lure 700 is such that it can be molded to have a realistic simulated shape, and proportions of a frog. Further, the body segments can be molded to be a distinct and realistically shaped like a frog. The fishing lure 600 in the frog arrangement may be molded, for example, from plastic material to a shape simulate multiple frog species. The linking system 100 can have one or more connection rods that permit the movement of the fishing lure's 700 body and legs. The fishing lure 700 can be relatively static when not swimming in the water, and the legs, and body can flutter or kick in the water when tension is applied to the fishing line.

Referring to FIG. 14, shows an apparatus for molding a fishing lure with in linking system. The fishing lure 10 can be formed by casting a mold in the shape of the fishing lure, inserting molten plastic into the mold, and allowing the plastic to setup in the shape of the mold. Prior to the mold process, the linking system 100 can be set within and substantially centered in the cast of the mold.

In embodiments, a mold 800 can be two or more pieces having a bottom piece 802 and a top piece 804. The mold can be cast as a unitary or one-piece fishing 10 lure having a head 810, body 812, tail 816 and linking system 100 molded within one-piece. The mold halves 802, 804 can each form the top half of the fishing lure, and the bottom half of the fishing lure each having one or more cavities for the fishing lure's appendages (not shown). The bottom piece 802 can contain a cavity 806 that a washer 108 can be placed in to support a vertical connection rod 128 and the linking system 100. The bottom piece 802 and a top piece 804 can have a wobbler cavity 808 that supports the wobbler device, and in other embodiments the wobbler device can be placed on the outside of the mold pieces, and yet another embodiment the wobbler device can be included in the head 810 of the fishing lure 10. The fishing line 114 can be pulled taut and locked into place allowing the linking system to sit centered within the mold cavity before the mold is poured. The washer cavity 806 can support the washer 108 keeping the vertical connection rod 128 positioned correctly and adding resistance against the linking system 100, and the line 114 being pulled taut. The combination of the washer cavity 806, and the line being pulled taut and locked into position allows the linking system 100 to be positioned correctly within the fishing lure 10.

A conventional source of pressurized molten plastic can be connected to the mold cavity gate 814. The bottom section 802 and a top section 804 can be held together by any conventional means during the mold process allowing one complete fishing lure 10 to be formed with the molten plastic is pushed into the cavities. The fishing lure 10 can be cast from any suitable material for example, plastic, rubber, polyvinyl chloride plasticized with esters such as phathalate, or the like. The method of molding a fishing lure 10 can start when the two halves are held tightly against together on a horizontal plane 816 where one or more notches and holes can lie on the bottom or top piece keeping the pieces aligned. Molten plastic can be forced under pressure through the entrance gate 814. The entrance gate 814 can be located on for example, either on the bottom piece 802 or on the top piece 804. As the plastic is pushed into the cavity, the plastic advances from the entrance gate 814 toward the front and back end of the fishing lure 10 cavity the pressure built up as the mold is pushed through the cavity is expelled between the space between the bottom piece 802 and the top piece 804.

Once the fishing lure 10 cavities are filled with molten plastic, the molten plastic can then be cooled by any conventional manner for example, put in a freezer, air cooled, or the like. After the plastic filling the cavity has been solidified, the mold halves can be separated, and the fishing lure can fall out of the mold. In certain embodiments, a mold can be in the shape of for example, a lizard, a fish, a frog, or the like.

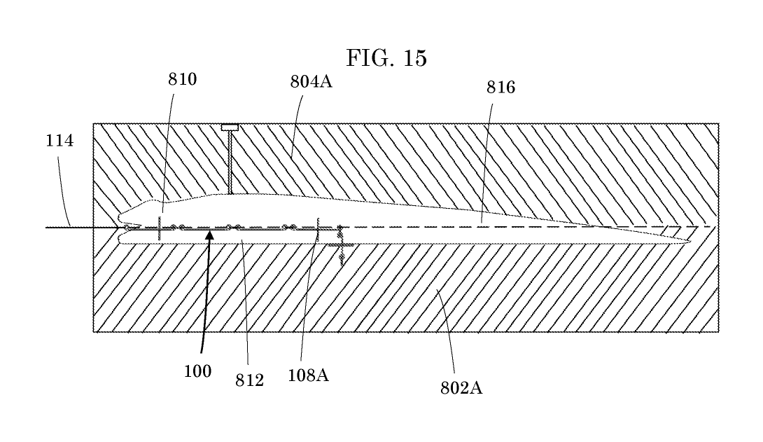

Referring to FIG. 15, shows another apparatus for molding a fishing lure with a linking system. The mold can be cast as a unitary or one-piece fishing 10 lure having a head 810, body 812, tail 816 and linking system 100 molded within one-piece. The mold halves 802A, 804A can each form the top half of the fishing lure, and the bottom half of the fishing lure each having one or more cavities for the fishing lure's appendages (not shown). The bottom piece 802A can contain a cavity 806 that a washer 108 can be placed in to support a vertical connection rod 128 and the linking system 100, or it can be omitted from the bottom piece. The fishing line 114 can be pulled taut and locked into place with a knot, or locking pin, or washer, or the like allowing the linking system to sit centered within the mold cavity before the mold is poured. The washer cavity 806 can support the washer 108 keeping the vertical connection rod 128 positioned correctly and adding resistance against the linking system 100, and the line 114 being pulled taut. The combination of the washer cavity 806, and the line being pulled taut and locked into position allows the linking system 100 to be positioned correctly within the fishing lure 10. One or more washers can be incorporated within the mold connected to or attached to the linking system 100.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present disclosure, which is defined solely by the claims. Accordingly, embodiments of the present disclosure are not limited to those precisely as shown and described.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the disclosed embodiments (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of the embodiments otherwise claimed. No language in the present specification should be construed as indicating any non-claimed element essential to the practice of the disclosed embodiments.

What is claimed is:

1. A fishing lure comprising:
a body portion having a head, and at least one appendage;
a linking system having at least one pivot, wherein the linking system is incorporated and secured within the body portion of the lure.

2. A fishing lure according to claim 1, wherein the at least one appendage is integrally formed to the body.

3. The fishing lure of claim 2, wherein linking system and pivots are placed to mimic the structure of bones and joints in an animal species.

4. A fishing lure according to claim 1, wherein the body portion is formed from plastic or rubber.

5. A fishing lure according to claim 1, wherein the body, the head, and the at least one appendage are flexible and wherein the body and the tail are configured to emulate the movement of an animal species as it swims through water.

6. A fishing lure according to claim 1, wherein the body has a tail, and wherein the linking system further comprises a forward pivot near the head, and an aft pivot near the tail, and connection rod between the forward pivot and the aft pivot.

7. A fishing lure according to claim 1, wherein the linking system further comprises a vertical connection which has a bottom loop and a top loop wherein a hook is attached to the bottom loop.

8. A fishing lure according to claim 6, wherein at least one appendage is connected to the body portion and wherein the linking system comprises one or more connection rods extending toward the least one appendage.

9. A fishing lure according to claim 8, wherein a link connects the connection rods together at the forward pivot and the aft pivot.

10. A fishing lure according to claim 1, wherein the body portion, the head, and the at least one appendage have a plurality of reflective pieces integrally formed within.

11. A fishing lure according to claim 1, wherein the fishing lure comprises at least one of a wobble device, a swivel, a line, a washer, and a weight wherein the washers are placed on one or more connection rods.

12. A fishing lure according to claim 10, wherein the wobble device magnifies the fishing lure's fluctuating body, and the at least one appendage.

13. A fishing lure according to claim 1, wherein the fishing lure is shaped to resemble a lizard, frog, fish, or worm.

14. The fishing lure of claim 1, wherein the link system comprises at least one link accessible to a user through the body portion of the lure and wherein an accessory or appendage can optionally be connected to the at least one link.

15. A fishing lure mold comprising:
a mold having a bottom section and a top section;
the top section, and the bottom section forming a cavity defining the shape of a body portion of a fishing lure, and an injection point through which material may be inserted into the cavity that allows a linking system to be held in place while the cavity is filled with material to form a unitary artificial fishing lure;

16. A fishing lure mold according to claim 15, wherein the top section, and the bottom section further comprise cavities for one or more appendages.

17. A fishing lure mold according to claim 15, wherein the bottom section further comprise a washer cavity for a washer, and a vertical connection rod.

18. A fishing lure mold according to claim 17, wherein the washer cavity supports the washer and the vertical connection rod, and the linking system coupled to the vertical connection rod.

19. A fishing lure mold according to claim 15, wherein the cavity supports a plurality of connection rods extending towards a forward portion of the cavity exiting out of the fishing lure's head wherein the connection rod is centered and placed towards the forward portion of the cavity.

20. A fishing lure mold according to claim 15, comprising a connecting point for a taut line that can hold the linking system in place when material is inserted into the mold through the injection point.

21. A fishing lure mold according to claim 15, wherein the cavity is in the form of a lizard, frog, fish, or worm.

22. The fishing lure mold according to claim 15 further comprising a receptacle to insert the linking system into the cavity of the mold such that gravity will hold the linking system in place when material is inserted into the cavity of the mold through the injection point.
